(19) United States
(12) Patent Application Publication
(10) Pub. No.: US 2005/0063487 A1
(43) Pub. Date: Mar. 24, 2005

(54) Method and apparatus for parameter estimation, modulation classification and interference characterization in satellite communication systems

(76) Inventor: Soheil Sayegh, Gaitherburg, MD (US)

Correspondence Address: SUGHRUE MION, PLLC, 2100 PENNSYLVANIA AVENUE, N.W., SUITE 800, WASHINGTON, DC, 20037, US

(21) Appl. No.: 10/476,869

(22) PCT Filed: May 8, 2002
(86) PCT No.: PCT/US02/14294

Related U.S. Application Data
(60) Provisional application No. 60/289,389, filed on May 8, 2001.

(51) Int. Cl. H04L 27/06

(52) U.S. Cl. 375/316

(57) ABSTRACT

A digital signal processing (DSP)-based approach to parameter estimation modulation identification and interference charaterization in connection with a satellite Communication Monitoring System (CSM). The techniques descried here also allow automatic generation of satellite frequency plans (S74) without any a priori knowledge of such plans. Individual processes for carrier isolation (S71), segmentation (S72), frequency estimation (S73), symbol rate estimation, bit error rate estimation, modulation identification and interference characterization are disclosed may be combined in a totally automated process.

This application claims the benefit of U.S. Provisional Application Ser. No. 60/289,389, filed on May 8, 2002.

### FIELD OF THE INVENTION

The invention relates generally to a satellite communication monitoring (CSM) method and apparatus for providing parameter estimation, modulation classification, and interference characterization in communication satellite systems.

### BACKGROUND

In a satellite communication system, particularly a system where the satellite is deployed in a geostationary orbit, the satellite will be able to receive signals transmitted to the satellite by earth stations at an allocated uplink frequency band and will be operative to transmit signals to earth stations on allocated downlink frequency bands. The uplink bands are selected to be spaced apart from the downlink bands in order to avoid interference. Nonetheless, interference may be generated due to transmissions from adjacent earth stations or adjacent satellites having overlapping beams. In addition, interference may arise from natural phenomena, such as rainfall, scattering, terrestrial communications and the like.

With respect to the downlink, the signal received at an earth station from the satellite is frequency-down-converted and digitized by means of an analog-to-digital (A/D) converter. A typical value for the bandwidth of the A/D converted frequency band is 36 MHz. The A/D converter output is a stream of bits which essentially captures all the information in the received signal.

FIG. 1 illustrates a satellite system 10 having a plurality of satellites 11, 12, 13, 14 in geostationary orbit, including a satellite 13 that is intended to communicate with an earth station 15 and several adjacent satellites 11, 12 and 14. Satellite 13 transmits signals on a downlink band to the earth station 15 having a frequency down converter, A/D converter and CSM equipment 18 that can provide conventional CSM functions. The CSM 18 has an adequate processing capability, which may be provided by a conventional processor (not shown) with appropriate software modules.

The CSM system 18 includes a digital spectrum analyzer, operating on the A/D output bits, that provides a panoramic look of the carriers in the entire frequency band that was digitized. In order to properly monitor the received signal, the carriers must be separated or isolated, and subdivided as needed. Then, an estimation made of their parameters, identifying their modulation types, as well as detecting and characterizing any interferer that may be present in the digitized frequency band. The successive steps involve carrier isolation, segmentation, frequency estimation, symbol rate estimation, bit error rate estimation, modulation classification and interference characterization.

Carrier Isolation:

Carrier isolation consists of identifying and separating the individual carriers in the digitized frequency band. After carrier isolation has been performed, each carrier is processed separately to estimate its parameters, determine its modulation type, etc. Typically, the carriers are identified on a spectrum analyzer by a human operator, in a straightforward and well known process.

However, automated carrier detection is difficult, as the process must be capable of differentiating true carriers from thermal noise, statistical fluctuations, side lobes, intermodulation products, and spurious spikes.

Segmentation:

For the sake of computational simplicity, it is often necessary to segment the time domain data record containing the digital samples into segments of appropriate size, and to process each segment separately. Furthermore, when the channel is not constant, segmentation has the additional advantage of providing a channel which is approximately constant over each segment. Examples of non-constant channels include bursty channels, fading channels, and voice activated channels. The size of the segment is usually chosen as a power of 2 because such a choice leads to the use of efficient FFT processing. FFT processing is the backbone of the digital spectrum analysis to be performed on such segments.

Frequency Estimation:

There are several well-known techniques to carrier frequency estimation.

One popular technique is the centroid method. In this method, the center frequency is estimated as a weighted average frequency, where the weights are taken as the squares of the spectral coefficients. A second method consists of fitting a straight line to the instantaneous phase data. Finding the best straight-line fit is a simple mean square error minimization problem, where the slope of the line provides the frequency estimate and the value at the origin provides the initial phase. When using this technique, the phase values must be unwrapped before the straight line fit A third method consists of passing the received waveform through a nonlinearity, such as quadrupling, and detecting spectral lines at harmonics of the carrier. The frequency location of these spectral lines, which are obtained via a high resolution FET, would provide an accurate estimate of the carrier frequency.

While the above three methods are suitable in many situations, they each have their shortcomings, making them unsuitable for some applications. For example, the centroid method is not suitable if the frequency spectrum is not symmetric. The instantaneous phase square error minimization is best suited to constant envelope modulations, and the nonlinearity does not always produce line spectra at harmonics of the carrier frequency. Furthermore, the accuracy provided by these methods may sometimes be insufficient.

Symbol Rate Estimation:

There are several well-known techniques for symbol rate estimation. One conventional scheme is the delay and multiply method, where the received waveform is multiplied by a replica of itself, that has been delayed by a fraction of the symbol rate. Spectral lines will then appear in the spectrum at harmonics of the symbol rate when the delay is properly chosen. The amount of delay, and the number and magnitude of spectral lines are modulation scheme-dependent and well known in each case. Those spectral lines therefore provide a signature identifying the symbol rate, and may also be used for modulation discrimination.

Another method is to use a first order phase lock loop (PLL) to track the timing of the received signal. This is a typical way of achieving clock synchronization in digital modems.

While the above methods are suitable for many situations, they each have their shortcomings, making them unsuitable for some applications. For example, the delay and multiply method does not always produce spectral lines at harmonics of the symbol rate. As to the PLL tracking method, it needs a sufficiently accurate knowledge of the symbol rate at the start.

BER Estimation:

When a signal is demodulated and FEC is decoded, it is possible to obtain an accurate estimate of the BER, without having access to the actual transmitted bits. BER is determined by a well-known procedure based on re-encoding the decoded bits.

In the absence of FEC decoding, an accurate BER estimate (coded or uncoded) may be obtained over an AWGN (additive white gaussian noise) channel from accurate estimation of energy per bit/noise density (Eb/No), and knowledge of the modulation format and FEC type and rate.

Estimating the uncoded and coded BER becomes more difficult if the channel is not AWGN. In order to provide a fairly accurate BER estimate in this case, understanding the nature and magnitude of the various channel impairments is paramount. Indeed, if by a process of reverse engineering one is able to completely determine all the channel impairments, then one could in principle reconstruct a waveform statistically identical to the one under examination, and therefore one would be able to accurately estimate the BER. In reality of course, it is not possible to completely determine all the channel impairments, and one would attempt to estimate them as accurately as possible.

Modulation Classification:

There are a number of well-know techniques for modulation classification. They mostly fall into one of two categories: pattern-recognition based and decision theory-based. The most practical techniques are a hybrid of these two approaches, where a set of key features is extracted from the modulated waveform (as in pattern recognition), and the principles of decision theory are applied to classify the modulation based on those features.

Numerous key features have been used for modulation classification. A partial list of those features include: amplitude histograms, frequency histograms, phase histograms, phase difference histograms, the variance of the amplitude, frequency, and phase, higher order moments, kurtosis, cumulants, the square of the signal envelope, zero crossings, the power spectrum of the received signal, the presence of harmonics at selected frequencies, the magnitude of the spectral component at twice the carrier frequency of the signal squared, the magnitude of the spectral component at 4 times the carrier frequency of the signal raised to the fourth power, and the power spectrum asymmetry.

If properly chosen and applied, the key features can help discriminate among different modulation formats, even under adverse conditions, such as low signal to noise ratio (SNR), limited amount of data, presence of interference, and channel impairments.

Existing modulation classification schemes typically have several shortcomings. One shortcoming is that the key features computation does not take into account that different samples have different reliability values, as they are often taken asynchronously with the signal symbols. Another shortcoming is that the band-limited nature of the waveform (which causes signal fluctuations around the symbol edges) is usually not taken into account A third shortcoming is that the outcome of a classification scheme is often dependent on the sequence of applying the key features. Another shortcoming is that the thresholds used in determining the decision regions are independent of SNR. A further shortcoming is that simple majority rule is used to make a final decision based on the individual segments decisions. Last but not least, is the fact that many existing classification schemes require exact knowledge of the signal parameters, and are not robust to inaccuracies in the value of those parameters. Unfortunately, the schemes that perform the best under idealized conditions tend to be the least robust.

Interference Characterization:

Interference identification and characterization can significantly enhance the utility of a Communication System Monitoring system. In this regard, “characterization” refers to determining the power level; carrier frequency and occupied bandwidth of the interferer, plus any other transmission parameters that may be estimated. Generalizing the interference characterization to the case of multiple interferers is done iteratively.

There are many potential sources of interference in a satellite communication system such as inclined satellites, radars, terrestrial microwave links, in-orbit test equipment generated carriers, rogue transmitters, and carriers on mistaken frequencies and/or directions. In addition, as previously noted, adjacent satellites in the geostationary arc are a main source of interference.

Adjacent Satellite Interference (ASI) can occur on the uplink and on the downlink. While the interference mechanism is different in these two cases, both uplink ASI and downlink ASI result in the presence of interfering signals in a frequency band. An interferer's power may be sufficiently low to make its detection and identification difficult, yet sufficiently high to cause noticeable performance degradation to desired signals.

Furthermore, the capability to characterize interferers in a desired frequency band can provide useful data on whether other satellite systems are abiding by the frequency coordination agreements to which they are party.

A practical algorithm for interference identification and characterization is known in the art. The received waveform consists of a distorted version of the desired signal, thermal noise, and an unknown interferer. It is desired to characterize the interferer to the extent possible. In other words, it is desired to determine the interferer power, center frequency, occupied bandwidth, modulation type, symbol rate, and any other potentially useful information. If one could completely cancel out the desired signal, standard correlation techniques could be used to extract interferer information from the thermal noise. However, the distortion of the desired signal makes its complete cancellation impractical. The goal is then to cancel the desired signal as much as possible so that any residual energy is small and does not mask the presence of an interferer.

Impairments that are expected to distort the desired signal waveform include: the non-ideal channel, phase noise, oscillator drift, transmitter non-linearities, non-ideal filtering, clock jitter, intermodulation products, and quadrature imbalance. In order to perform a fairly complete cancellation of the strong signal in this case, understanding the nature and magnitude of the various channel impairments is paramount. Indeed, if by a process of reverse engineering one is able to completely determine all the channel impairments, then one could in principle reconstruct a noise-free, identical copy of the desired signal in the received waveform. Subtracting this constructed replica from the received waveform would leave the interferer and the noise. In reality of course, it is not possible to construct a perfect noise-free copy of the desired signal in the received waveform. The desired approach is to construct as close a replica as possible of the received desired signal by estimating the impairments as accurately as possible. The extent to which it is possible to estimate those impairments and cancel out their effect will determine the degree of success in characterizing the interference.

As many of the foregoing processes and procedures are manual or only semi-automated, it is an object of the present invention to provide fully automated procedures for determining each of these satellite performance related parameters.

It is also an object of the invention to provide a combination of automated procedures that can attain an automatic generation of satellite frequency plans.

It is yet an object of the invention to provide a combination of at least two and possibly all of the automated procedures in order to obtain an optimum result.

### SUMMARY OF THE INVENTION

The present invention is a digital signal processing (DSP)-based approach to parameter estimation, modulation identification and interference characterization in connection with a satellite Communication Monitoring System (CSM). The techniques described here allow automatic generation of satellite frequency plans without any a priori knowledge of such plans. When combined with information publicly available about a given satellite, these techniques will give very precise information of the frequency plan of that satellite.

### BRIEF DESCRIPTION OF THE DRAWINGS

FIG. 1 is a schematic illustration of a satellite system where CSM would be utilized.

FIG. 2 is a flowchart for a procedure that performs an automated carrier isolation process.

FIG. 3 is a flowchart for a procedure that performs an automated carrier segmentation process.

FIG. 4 is a flowchart for a procedure that performs an automated carrier frequency estimation process.

FIG. 5 is a flowchart for a procedure that performs an automated symbol rate estimation process.

FIG. 6 is a flowchart for a procedure that performs an automated bit error rate (BER) estimation process.

FIG. 7 is a flowchart for a procedure that performs an automated modulation classification process.

FIG. 8 is a flowchart for a procedure that performs an automated interference identification and characterization process.

FIG. 9A is a flowchart for a procedure that integrates three of the foregoing automated processes to achieve an automatic generation of a satellite frequency plan.

FIG. 9B is a flowchart for a procedure that integrates all of the foregoing automated processes.

### DETAILED DESCRIPTION OF THE INVENTION

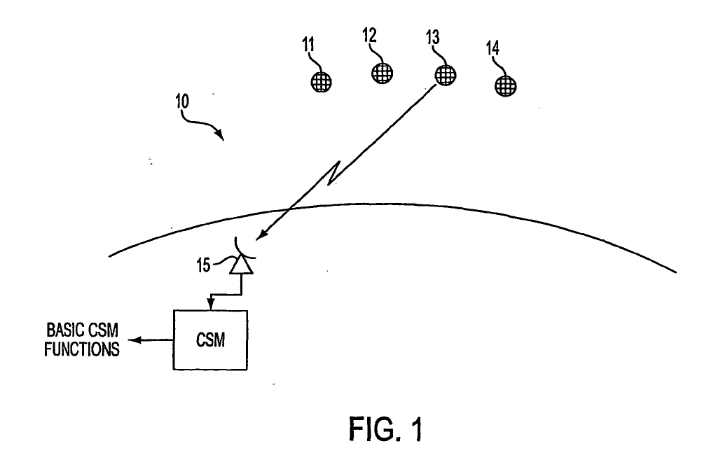

In a satellite communication system as illustrated in FIG. 1, where a CSM system is available to perform various system monitoring, analysis and estimation functions, the processor resident at the CSM may be operative to perform a variety of procedures, consistent with the algorithms identified subsequently in flowchart form, to automatically estimate parameters, classify modulation and characterize interference in the system. While the invention is disclosed in connection with various specific embodiments, it is not limited thereto and a wide variety of alternative approaches may be evident to one skilled in the art upon reading the following disclosure. For example, the processing performed may be distributed or centralized, with communication with an earth station provided by well known network and system arrangements.

Turning now to the individual elements of the signal processing performed in a CSM system contemplated by the present invention, the following procedures may be employed.

Carrier Isolation:

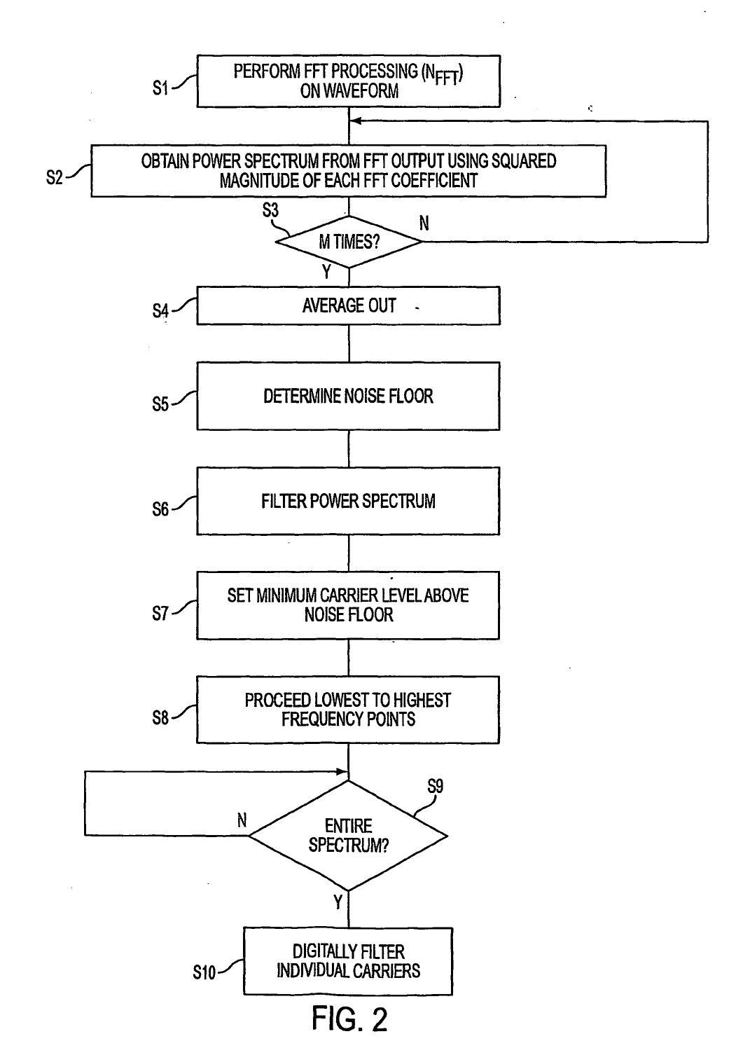

Carrier isolation would be automatically performed in accordance with the following procedure, consistent with the flowchart illustrated in FIG. 2. In a first step S1, the processor serving the CSM would perform an FFT of size N_{FFT} on the composite waveform of bandwidth W. The value of N_{FFT} is programmable, and may be given a default value, such as but not limited to 1024. In step S2, the power spectrum is obtained from the FFT output by computing the squared magnitude of each FFT coefficient. This procedure is repeated M times according to step S3 and averaged out in step S4 to smooth out the statistical fluctuations in the spectrum. The value of M is programmable, and in an exemplary embodiment, may have a default value of 16, although other values would be readily apparent to one skilled in the art. Then, a noise floor pₙ is determined in step S5.

With these basic parameters in hand, the power spectrum is filtered in step S6 in order to mitigate the impact of any statistical fluctuations, and to gloss over spurious spikes and frequency nulls between sidelobes. Then, in step S7, a minimum carrier level p_{c} X dB above the noise floor pₙ is set, where X is a programmable parameter, which may have a default value of 3 dB, or other value as would be apparent to one skilled in the art.

The processing will proceed through the individual frequency points from the lowest to the highest, in step S8. When a value higher than p_{c} is first detected at a certain frequency, that frequency is taken as the lower frequency limit of a carrier in step S8. Also, in that same step, when the value at the filter output drops first to a level below p_{c}, the corresponding frequency is taken as the upper frequency limit of the carrier. The entire spectrum is processed according to the procedure of step S8, as indicated in step S9, thus identifying the lower and upper frequency limits for each carrier. Finally, in step S10, the individual carriers are digitally filtered out, one by one, in accordance with the procedure identified above. Thereafter, the procedure comes to an end.

Segmentation:

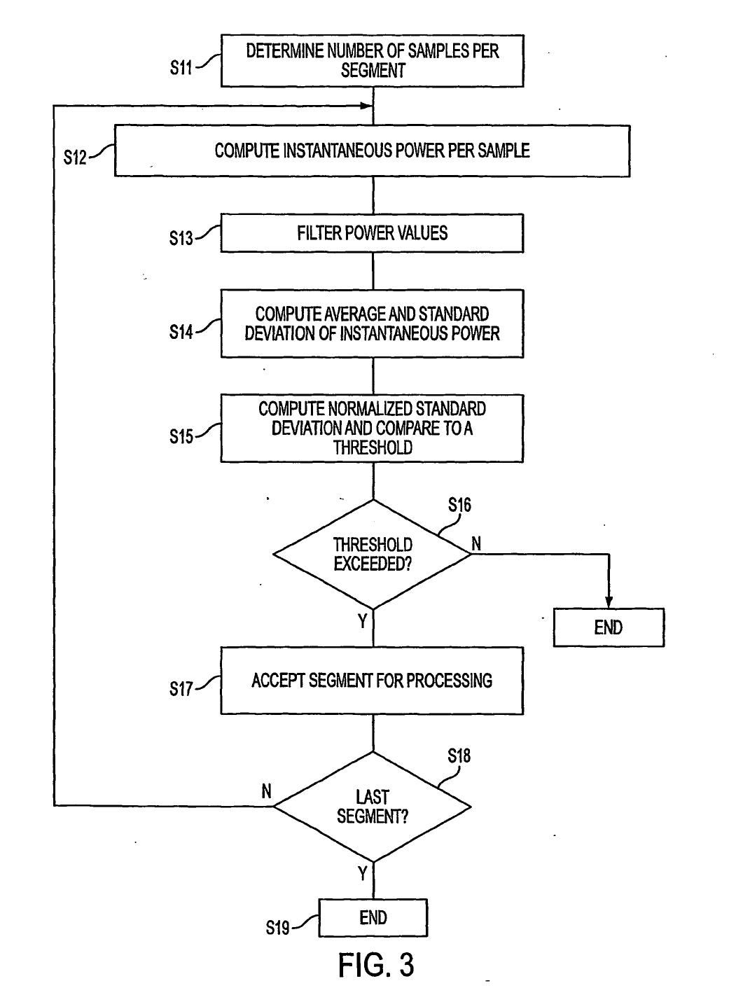

Segmentation would be automatically performed in accordance with the following procedure, consistent with the flowchart illustrated in FIG. 3. In a first step S11, a number of samples that are to be included in a segment are determined and a suitable power of 2 is identified to represent the selected number of samples in the segment. Then, in step S12, the instantaneous power in each sample is computed. Next, in step S13, the instantaneous power values are filtered out in order to remove large deviations. In step S14, the average and the standard deviation of the instantaneous power is computed and, in step S15, the normalized standard deviation is computed and compared to a threshold based on the value of Eb/No, where Eb is the signal strength and No is a corresponding noise value. In step S16, it is determined whether the threshold is exceeded. If not exceeded, the segment is rejected (N), otherwise (Y), it is accepted in step S17. Then in step S18, it is determined whether the analyzed segment is the last segment and, if not, the process proceeds to test the next segment If it is the last segment, the process ends.

Frequency Estimation:

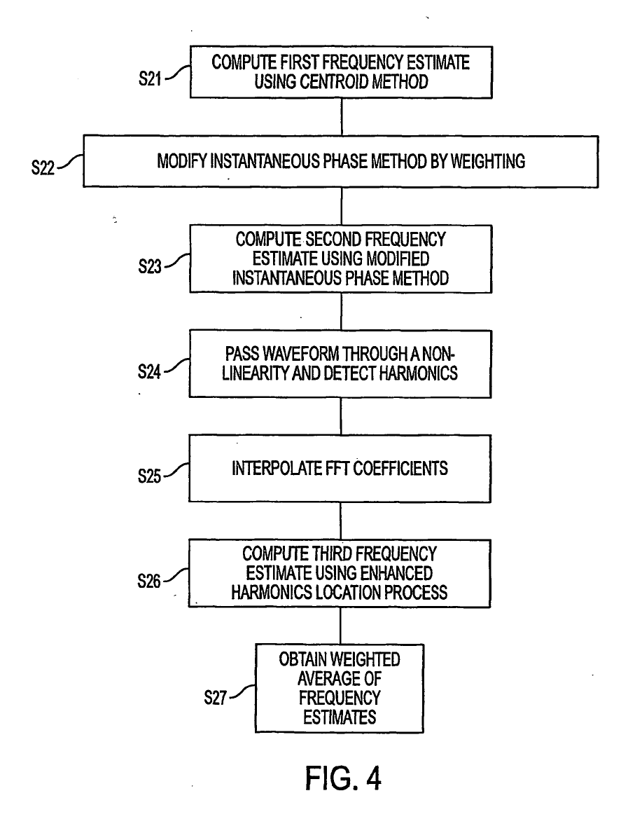

Frequency estimation is automatically performed in accordance with the following procedure, consistent with the flowchart illustrated in FIG. 4. In a first step S21, the processor would compute a frequency estimate using the well known centroid method. Then, in step S22, the instantaneous phase method is modified. The modification would be made as follows. Assign a weight proportional to the square of the magnitude to each instantaneous phase value, so that samples with higher SNR are given more weight. Use a weighted minimum mean square error criterion. Then, in step S23, a second frequency estimate is computed using the modified instantaneous phase method as described above.

In step S24, the waveform is passed through a non-linearity and any harmonics in the spectrum are detected. In step S25, the FFT-based location of harmonics is enhanced by using unbiased interpolation of the FFT coefficients. Finally, in step S26, a third frequency estimate is determined on the basis of the enhanced harmonics location process, as previously disclosed.

Once the three frequency estimates are obtained, although more may be obtained if desired, a weighted average of the frequency estimates is determined in step S27. The weights are assigned on the basis of spectral symmetry, envelope fluctuations, and strength of the frequency harmonics.

As would be understood by one skilled in the art, if only a moderate frequency estimation accuracy is sought, a subset of the above set of estimates would be adequate. On the other hand, if higher frequency accuracy is still needed, supplement the estimate obtained above with a phase locked loop to track the received carrier.

Symbol Rate Estimation:

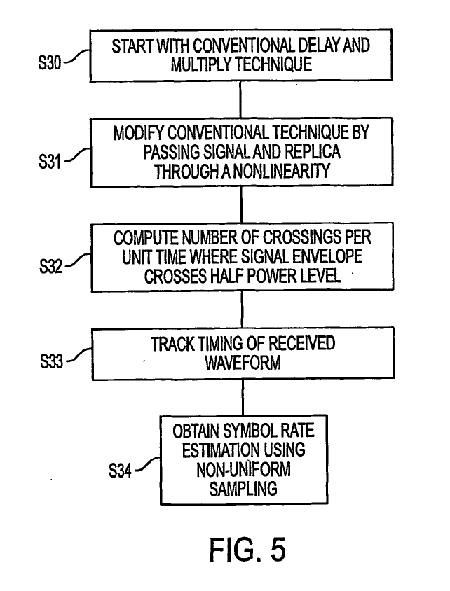

Symbol rate estimation is automatically performed in accordance with the following procedure, consistent with the flowchart illustrated in FIG. 5, using a modification of the conventional delay and multiply technique. According to the modification, in a step S31, both the received signal and its delayed replica are passed through a nonlinearity to produce harmonics at the symbol rate. Then, in step S32, the processor would compute the number of crossings per unit time where the signal envelope crosses the half power level. In step S33, the timing (clock frequency and phase) of the received waveform would be tracked, in an exemplary embodiment, by using a second order PLL.

In a subsequent process represented by step S34, a non-uniform sampling approach would be used. For example, but without limitation, a non-uniformly sampled set may be generated by digital interpolation between the available uniformly sampled samples. The proposed non-uniform sampling rate is slowly and monotonically increasing, and covers the range of uncertainty in the symbol rate. This provides the ability to home in on the true sample rate. Once lock is achieved, uniform sampling is resumed and a PLL is used to fine tune the symbol rate estimate.

If only a moderate symbol rate estimation accuracy is sought, a subset of the above set of estimates would be adequate.

BER Estimation:

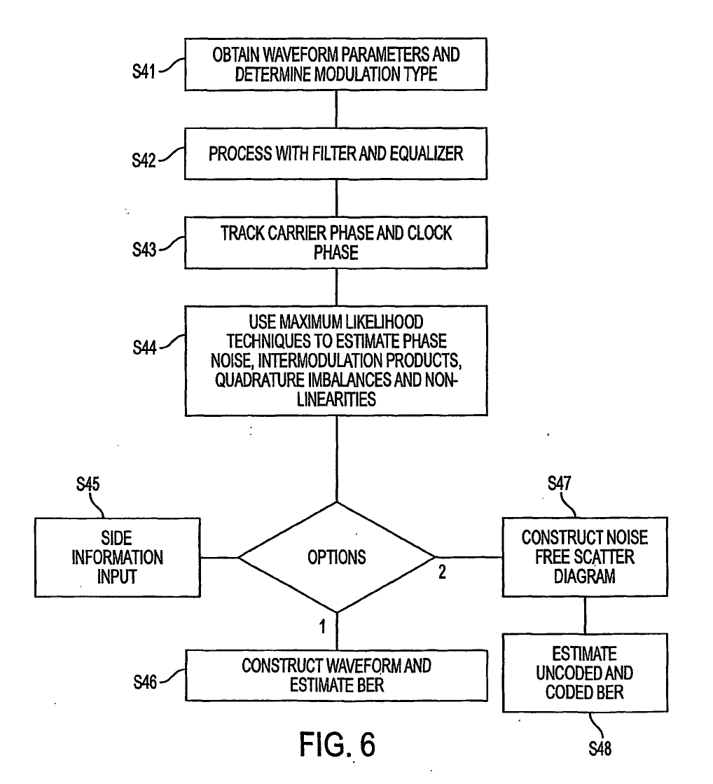

Bit error rate estimation is automatically performed in accordance with the following procedure, consistent with the flowchart illustrated in FIG. 6. According to step S41, the process begins with an estimate the waveform parameters and a determine the modulation type, if it is not already known, as described above. Then, in step S42, there is a processing of the received samples with a properly matched and equalized filter, followed by a tracking of the carrier phase and the clock phase in step S43. In step S44, the well known maximum likelihood techniques are used to estimate the phase noise, intermodulation products, quadrature imbalances, and non-linearity's.

Any side information available regarding the transmitter characteristics, such as for example the power amplifier specifications, may be used for this purpose in step S45. The information may be available beforehand and either input manually or accessible automatically by the processor on the basis of pre-stored information in RAM or auto detected characteristics of the equipment, in a manner known in the art.

The process proceeds in option 1 to the construction of a waveform with the estimated parameters and modulation type, subject it to the estimated impairments, and estimate the BER, in step S46.

Alternatively, the process may proceed as option 2 to step S47 by first constructing a noise-free scattering diagram based on the estimated impairments. Then, an estimate of the uncoded and coded BER, using maximum likelihood, may be obtained from the noise-free scattering diagram, and the estimated Eb/No in step S48.

Modulation Classification:

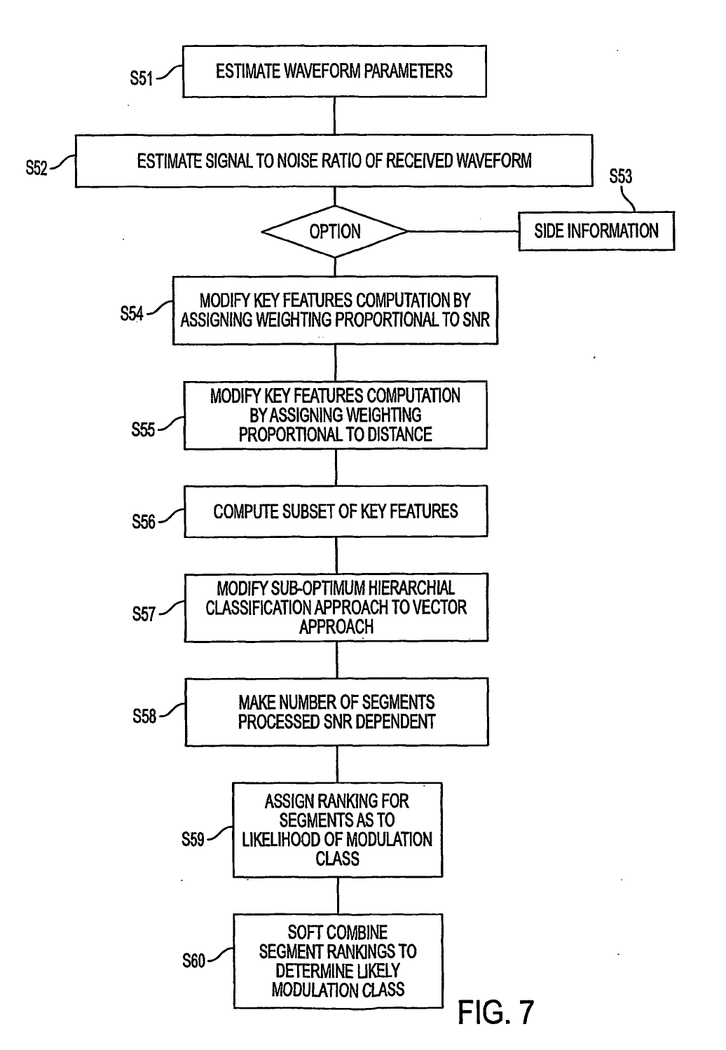

Modulation classification is automatically performed in accordance with the following procedure, consistent with the flowchart illustrated in FIG. 7. According to step S51, an estimate is automatically made of the waveform parameters as accurately as possible, as outlined above. Then, an estimate of the signal-to-noise ratio (SNR) of the received waveform is obtained in step S52.

Available side information, if any, may be used to narrow down the set of potential modulation formats at this point, according to step S53. The information may be available beforehand and either input manually or accessible automatically by the processor on the basis of pre-stored information in RAM or auto detected characteristics of the equipment, in a manner known in the art. Then several modification steps occur.

In step S54, the key features computation is modified such that each sample contributing to a key feature is assigned a weight proportional to its SNR. (Some phase samples are more sensitive to noise than others, depending on the magnitude of those samples.) In step S55, the key features computation is modified such that each sample contributing to a key feature is assigned a weight proportional to its distance from the symbol edges. (Band limiting causes envelope fluctuations around the symbol edges). In step S56, based on the side information, a subset of key features from the set listed above is computed. Then, in step S57, the sub-optimum hierarchical classification approach to a vector approach is modified, where several features are applied simultaneously to a multidimensional threshold. The threshold setting is made SNR-dependent. (Actual threshold values for different SNRs are computed offline).

In step S58, the number of segments processed is made SNR-dependent to achieve a given confidence level. And, in step S59, for each segment processed, a ranking is assigned as to how likely it is that the waveform under examination belongs to each of the modulation classes under consideration.

Finally, in step S60, a soft combining of all the segment rankings is performed to arrive at the most likely overall classification of a modulation type.

Interference Characterization:

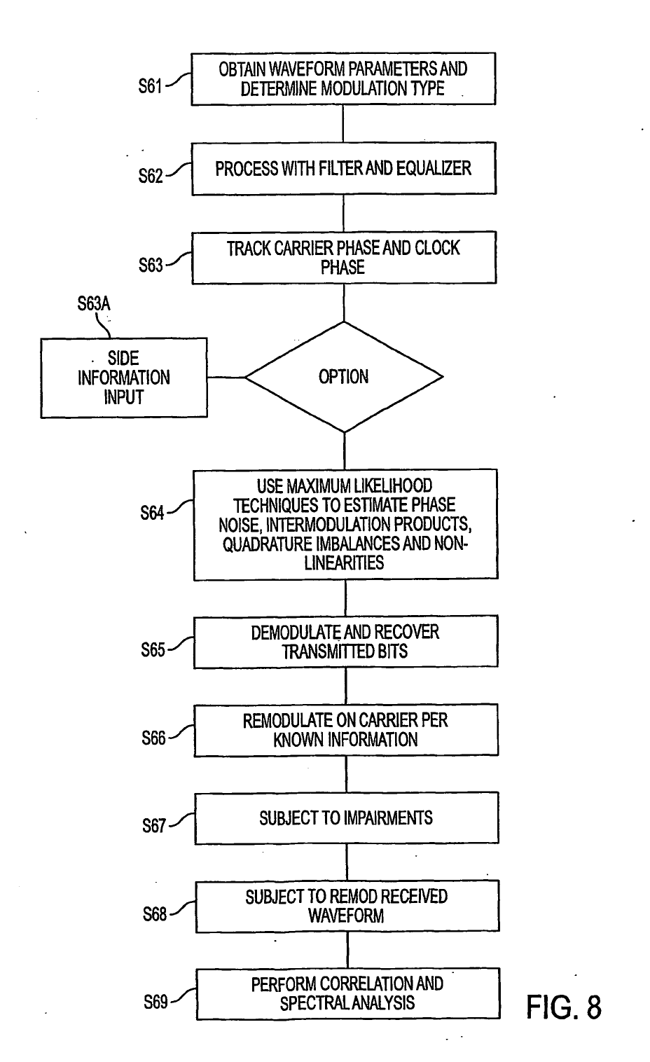

Interference characterization is automatically performed in accordance with the following procedure, consistent with the flowchart illustrated in FIG. 8. According to step S61, an estimate is made of the waveform parameters and a determination is made of the modulation type of the desired signal, if it is not already known, as described earlier.

In step S62, the received samples are processed with a properly matched and equalized filter. Then, in step S63, the carrier phase and the clock phase are tracked.

Any side information available regarding the transmitter characteristics, such as for example the power amplifier specifications, may be used in this regard and optionally input. The information may be available beforehand and either input manually or accessible automatically by the processor in step S63A on the basis of pre-stored information in RAM or auto detected characteristics of the equipment, in a manner known in the art.

In step S64, the well known maximum likelihood techniques is used to estimate the phase noise, intermodulation products, quadrature imbalances, and nonlinearities. Then, in step S65, the received signal is demodulated and the transmitted bits are recovered. Optionally, if the SNR is low and the error rate is high, FEC decoding of the signal to recover the information bits can be beneficial in this step. If FEC decoding was performed, the information bits must be re-encoded.

In step S66, the transmitted bits are remodulated on a carrier according to the known (or estimated) modulation type, symbol rate, and filter characteristics. The remodulated signal is subjected to the impairments estimated above in step S67 and the remodulated signal from the received waveform in step S68. A standard correlation and spectral analysis techniques is performed on the residual signal to extract interferer information from the noise, in step S69.

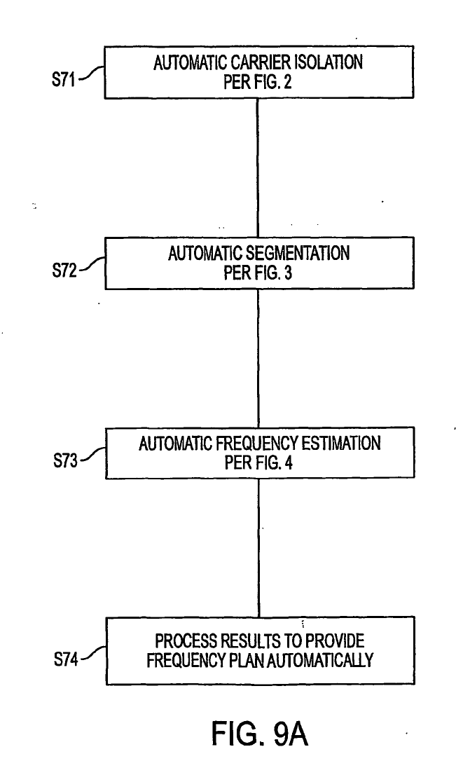

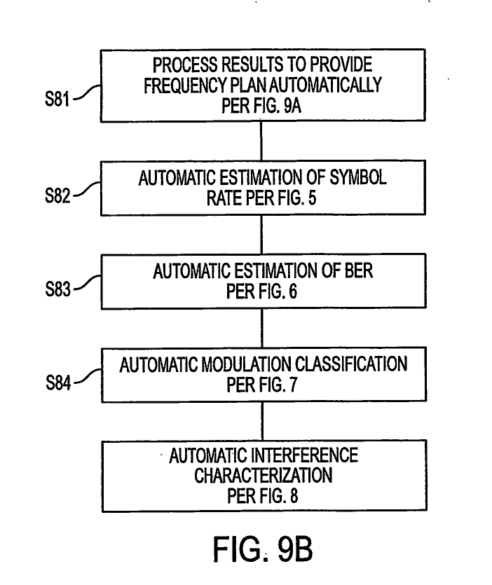

The several processes for automated determination of parameters may be combined to provide an automatic generation of a satellite frequency plan, as illustrated in FIG. 1, and according to the process of FIG. 9A. Specifically, the carrier is isolated automatically, according to the process in FIG. 2, in step S71. The carrier isolation is followed by a segmentation processing in step S72, according to the flowchart of FIG. 3. Thereafter, a frequency estimation process according to the method of FIG. 4 is conducted automatically in step S73. The result of this combination of outputs would be automatically combined into a frequency plan for a satellite by the CSM in step S74.

The several processes disclosed in FIGS. 2-8 may be conducted automatically, in any combination, as would be known in the art, including a combination of all of the processes as illustrated in FIG. 9B. There, as in FIG. 9A, the carrier isolation, segmentation and frequency estimation processes, which derive a frequency plan in step 81, may be accompanied by the estimation of symbol rate according to the process of FIG. 5 in step S82 and the estimation of BER according to the process of FIG. 6 in step S83 The modulation classification according to FIG. 7 may be performed in step S84 and the interference characterization according to FIG. 8 may be performed in step S85.

While the present invention has been described in accordance with certain embodiments and examples, it is not limited thereto.

1. A method of automatically isolating carriers of a composite waveform having a bandwidth in a satellite communication system, comprising:
a) performing an FFT processing of size N_{FFT} on the composite waveform, where the value of N_{FFT} is programmable;
b) obtaining a power spectrum from the FFT processing by computing the squared magnitude of each FFT coefficient;
c) repeating step b) a plurality of times and averaging the results;
d) setting, a noise floor pₙ;
e) filtering the power spectrum;
f) setting a minimum carrier level p_{c} X dB above the noise floor pₙ, where X is a programmable parameter,
g) identifying the lower and upper frequency limits for each carrier; and
h) digitally filtering the individual carriers.

2. The method of claim 1 wherein, when a value higher than p_{c} is first detected at a certain frequency, that frequency is taken as the lower frequency limit of a carrier and when the value at the filter output drops first to a level below p_{c}, the corresponding frequency is taken as the upper frequency limit of the carrier.

3. The method of claim 1 wherein. The processing proceeds through individual frequency points within the spectrum.

4. A method of automatically providing segmentation of time domain data record in a satellite communication system comprising:
a) determining a number of samples that are to be included in a segment;
b) computing, the instantaneous power in each sample;
c) filtering instantaneous power values;
d) computing an average and a standard deviation of the instantaneous power;
e) computing a normalized standard deviation and comparing the normalized standard deviation to a threshold;
f) determining whether the threshold is exceeded and if not exceeded, the segment is rejected, otherwise, it is accepted; and
g) repeating the foregoing process for at least one additional segment.

5. The method of claim 4 wherein the determining step includes identifying a suitable power of 2 to represent the selected number of samples in the segment.

6. The method of claim 4 wherein the threshold of step e) is based on a value of Eb/No, where Eb is the signal strength and No is a corresponding noise value.

7. A method of automatically estimating frequency in a satellite communication system comprising:
a) computing a frequency estimate;
b) providing a modified an instantaneous phase method;
c) computing a second frequency estimate is computed using the modified instantaneous phase method;
d) detecting any harmonics in the spectrum;
e) enhancing a FFT-based location of harmonics by using unbiased interpolation of the FFT coefficients;
f) computing a third frequency estimate on the basis of the enhanced harmonics location process;
g) determining a weighted average of the frequency estimates;
h) assigning weights on the basis of spectral symmetry, envelope fluctuations, and strength of the frequency harmonics.

8. The method of claim 7 wherein step a) uses the centroid method.

9. The method of claim 7 wherein the modifying step comprises assigning a weight proportional to the square of the magnitude to each instantaneous phase value, so that samples with higher SNR are given more weight.

10. The method of claim 7 wherein the waveform is passed through a non-linearity

11. The method of claim 7 further comprising using a phase locked loop (PLL) to track the received carrier.

12. A method of automatically estimating symbol rate in a satellite communication system comprising:
a) applying a delay and multiply technique wherein both a received signal and its delayed replica are passed through a non-linearity to produce harmonics at the symbol rate;
b) computing the number of crossings per unit time where a signal envelope crosses a half power level;
c) tracking the timing of the received waveform;
d) providing non-uniform sampling at a non-uniform sampling rate that is slowly and monotonically increasing, and covers the range of uncertainty in the symbol rate;
e) once lock is achieved, resuming uniform sampling; and
f) using a PLL to fine tune the symbol rate estimate.

13. The method of claim 12 wherein the timing step comprises tracking clock frequency and phase, using a second order PLL.

14. The method of claim 12 wherein said non-uniform sampling comprises generating a set by digital interpolation between the available uniformly sampled samples.

15. A method of automatically estimating bit error rate on received signals in a satellite communication system, comprising:
a) processing the received signals with a properly matched and equalized filter;
b) tracking of the carrier phase and the clock phase;
c) using maximum likelihood techniques to estimate one or more of the phase noise, intermodulation products, quadrature imbalances, and non-linearity's.
d) constructing a waveform with estimated parameters and modulation type;
e) subjecting the waveform to estimated impairments,
f) estimating the bit error rate.

16. The method of claim 15 further comprising, estimating the waveform parameters and determining the modulation type.

17. The method of claim 15 further comprising automatically considering side information regarding the transmitter characteristics.

18. The method of claim 15 further comprising constructing a noise-free scattering diagram based on the estimated impairments, estimating the uncoded and coded BER, using maximum likelihood, from the noise-free scattering diagram, and obtaining an estimated Eb/No, where Eb is the signal strength and No is a corresponding noise value.

19. A method of automatically classifying modulation of a received signal in a satellite communication system, comprising:
a) estimating the parameters of the received signal waveform;
b) estimating the signal-to-noise ratio (SNR) of the received signal waveform;
c) assigning each sample contributing to a key feature a weight proportional to its SNR;
d) modifying the key features computation such that each sample contributing to a key feature is assigned a weight proportional to its distance from the symbol edges;
e) modifying a sub-optimum hierarchical classification approach to a vector approach, wherein several features are applied simultaneously to a multidimensional threshold;
f) making the number of segments processed SNR-dependent;
g) for each segment processed, assign a ranking as to how likely it is that the waveform under examination belongs to each of the modulation classes under consideration; and
h) soft combining all the segment rankings to arrive at the most likely overall classification of a modulation type.

20. The method of claim 19, further comprising using side information to narrow down the set of potential modulation formats.

21. The method of claim 19 wherein, in the modifying step e) the threshold setting is made SNR-dependent;

22. The method of claim 19 wherein the side information is input automatically from a data base.

23. A method of automatically characterizing interference in a satellite communication system comprising:
a) obtaining waveform parameters and modulation type of the desired signal,
b) processing the received samples with a properly matched and equalized filter;
c) tracking the carrier phase and the clock phase;
d) estimating at least one of the phase noise, intermodulation products, quadrature imbalances, and non-linearity's using maximum likelihood techniques;
e) demodulating the received signal and recovering the transmitted bits;
f) remodulating the transmitted bits on a carrier according to the modulation type, symbol rate, and filter characteristics; and
g) performing a correlation and spectral analysis on the residual signal to extract interferer information from the noise.

24. The method of claim 23 further comprising estimating the parameters.

25. The method of claim 23 further comprising and automatically determining modulation type.

26. The method of claim 23 further comprising using side information available regarding the transmitter characteristics.

27. The method of claim 23 wherein, if the SNR is low and the error rate is high, applying FEC decoding of the signal to recover the information bits; and
re-encoding the information bits.

28. A method of automatically generating a satellite frequency plan in a satellite system based on signals received from a satellite, comprising:
a) isolating the carrier is isolated automatically;
b) segmentation processing the received signal; and
c) automatically estimating the frequency
d) automatically combining the result of carrier isolation, segmentation and frequency estimation to develop a frequency plan for the satellite.

29. An automated CSM system for use in a satellite communication system and operative to implement any one of the methods set forth in claim 1.
